(19) United States
(12) Patent Application Publication
(10) Pub. No.: US 2011/0238564 A1
(43) Pub. Date: Sep. 29, 2011

(54) System and Method for Early Detection of Fraudulent Transactions

(76) Inventors: Kwang Hyun Lim, South San Francisco, CA (US); Richard Louis Delery, Fremont, CA (US)

(21) Appl. No.: 13/072,356

(22) Filed: Mar. 25, 2011

Related U.S. Application Data
(60) Provisional application No. 61/318,188, filed on Mar. 26, 2010.

(51) Int. Cl. G06Q 40/00

(52) U.S. Cl. 705/38

(57) ABSTRACT

Systems, methods, and computer-readable media are disclosed for improved early detection and alerts related to fraudulent transactions. Certain embodiments involve sending an alert message to a mobile device associated with a portable consumer device. The alert includes notification of a recent transaction related to an account that is associated with the portable consumer device. A reply message is then received in response to the alert message. The response may indicate that the recent transaction is fraudulent. A risk engine is then updated with data associated with the reply message. In one potential additional embodiments, analysis and projections of potential future fraud are created or updated based on the reply message.

### CROSS-REFERENCES TO RELATED APPLICATIONS

This application is a non-provisional of and claims the benefit of the filing date of U.S. Provisional Patent Application No. 61/318,188, filed on Mar. 26, 2010, which is herein incorporated by reference in its entirety for all purposes. This application also incorporates the contents of the U.S. patent application Ser. No. 12/563,586, entitled “Intelligent Alert System and Method,” filed Sep. 21, 2009; U.S. patent application Ser. No. 12/720,627, entitled “Alert Architecture,” filed on Mar. 9, 2010; and the U.S. patent application Ser. No. 12/712,870, entitled “System and Method Including Indirect Approval,” filed on Feb. 25, 2010, in their entirety by reference for all purposes.

### BACKGROUND

A payment processing network can refer to a network that performs transaction processing such as payment processing for credit and debit card payments. Payment authentication and verification are primary functions of a payment processing network. In many instances, a payment processing network structure only allows short periods of time for completing an authorization in a context where large numbers of transactions are being processed on a continuous basis. In spite of these demands, the increasing functionality and performance of computing systems may allow added functionality or support for other priorities within a payment processing network. Fraud detection and messaging are two potential examples of additional functionality.

Alert messages can be derived from the inherent information in each transaction and other customization settings. Alert messages provide a means of notifying a user about recent transactions and/or account activities in a tailored format. Such alerts may be in the form of messages tailored based on various metrics. These metrics may specify the type of information a user wants to see such as recent transactions, account balances, transaction amounts over specified pre-set limits, and/or a format of the alerts which may specify the language, amount of detail, and the type of user devices used to receive the messages, among others.

Additionally, a major source of inefficiency and loss within a payment processing network is from fraud where a number, identity, or other information that may be used to initiate and complete a transaction is misappropriated. Because of the time and processing resource limitations mentioned above, a payment processing network has a limited opportunity to be involved in detection of fraudulent transactions, while at the same time being positioned to have important and early information that may be related to fraud detection. Although some methods of detecting fraud exist, theft and fraud in payment transactions continues to occur at a rate that reaches into the hundreds of millions and billions of dollars per year.

There is therefore a need for improved fraud analysis and detection in payment processing networks. Embodiments of the invention address these and other problems, providing for improved systems and methods for early detection of fraudulent transactions.

### BRIEF SUMMARY

Aspects of the embodiments of the present invention relate in general to improved methods for detection and prevention of fraudulent transactions. Such systems allow for improved detection of fraudulent transactions using a messaging system to receive messages and feedback from a user in response to queries regarding transaction authenticity. Such systems further allow for improved analysis and modeling of potential future fraudulent transactions, and for improved warnings to users, merchants, and others related to potential future fraudulent transactions. By operating as part of a payment processing network, such improved systems allow faster and more efficient use of data related to fraud detection.

Aspects also include mobile devices such as phones, portable consumer devices such as credit cards, and risk engines within payment processing networks that have access to two way messaging systems.

One embodiment of the invention is directed to a method for improved fraud detection and warning that includes sending an alert message to a mobile device that is associated with a portable consumer device. In such a system, the alert message may provide notification of a recent transaction related to an account that is associated with the portable consumer device. A person who receives an alert message may send a reply message in response to the alert message with the reply message indicating that the recent transaction on the user's account is fraudulent. When a risk engine receives the reply message, the risk engine is updated with data associated with the reply message.

Another embodiment is directed to further methods where the risk engine uses data from a reply message to identify other potential fraudulent transactions. Such fraudulent transactions may be based on monitoring specific merchants, geographic areas, or user groups. A messaging system that is part of the payment processing network may then communicate fraud risk to merchants, users, or other parties based on a risk analysis that used data from a reply message.

In various embodiments, the mobile device may be a smart phone, a personal computer, or another computing device, and may communicate with the payment processing network via text messaging, e-mail, or through a custom application.

In another embodiment, a risk engine that is part of a fraud detection system includes a database with alert customization data so that an alert message may be generated using identifying data from a recent transaction and from alert customization data. The alert message may then be generated using additional information such as a merchant identifier to determine a message template that is used to generate the alert message. The alert message may also include issuer data from the database.

Another embodiment of the invention can be directed to messages and replies from multiple mobile devices including mobile devices of third parties. Responses from any mobile device may be used to update a risk engine. In such an embodiment, multiple mobile devices may be associated with a user, or a mobile device may be associated with a third party user, and both are associated with an account or portable consumer device.

These and other embodiments of the invention are described in further detail below.

### BRIEF DESCRIPTION OF THE DRAWINGS

FIG. 1 shows a system, according to an embodiments of the innovations presented herein.

FIG. 2a illustrates an example of an alert message, according to an embodiment of the innovations presented herein.

FIG. 2b illustrates an example of an alert message, according to an embodiment of the innovations presented herein.

FIG. 3 illustrates a flowchart describing the operation of the system of FIG. 1, according to an embodiment of the innovations presented herein.

FIG. 4 shows a system, according to an embodiment of the innovations presented herein.

FIG. 5 shows a system, according to an embodiment of the innovations presented herein.

FIG. 6 shows a system, according to an embodiment of the innovations presented herein.

FIG. 7 shows a system, according to an embodiment of the innovations presented herein.

FIG. 8 illustrates a flowchart describing the operation of the system of FIG. 7, according to an embodiment of the innovations presented herein.

### DETAILED DESCRIPTION

Embodiments of the innovations disclosed herein include systems and methods for using alert messages in identifying and preventing possible fraudulent transactions.

In one non-limiting embodiment, a user registers for an alert system, and associates a credit card with a cell phone. During or just after a transaction involving the credit card, a risk engine sends a message to the cell phone asking the user to respond if they do not recognize the transaction. If the user does respond to indicate a fraudulent transaction, the risk engine is updated using the response to predict potential future fraud. The risk system may use the response or related data to identify locations, groups of similar users, types of merchants, or other patterns that may be used to predict potential future fraud. In some circumstances, messages may be sent to users, merchants, or issuers with an indication that certain types of fraud may be expected based on analysis from a risk engine.

In further embodiments, alert messages to third parties may be incorporated into the system. The associated replies from third parties may be incorporated into the risk engine for increasing a risk associated with a particular user. A third party reply may also be used to increase a priority related to allocating resources attempting to contact a user and to increase resources allocated to analyzing similar or related transactions.

### I. Risk Assessment and Payment Transaction System with Two Way Alert Messages

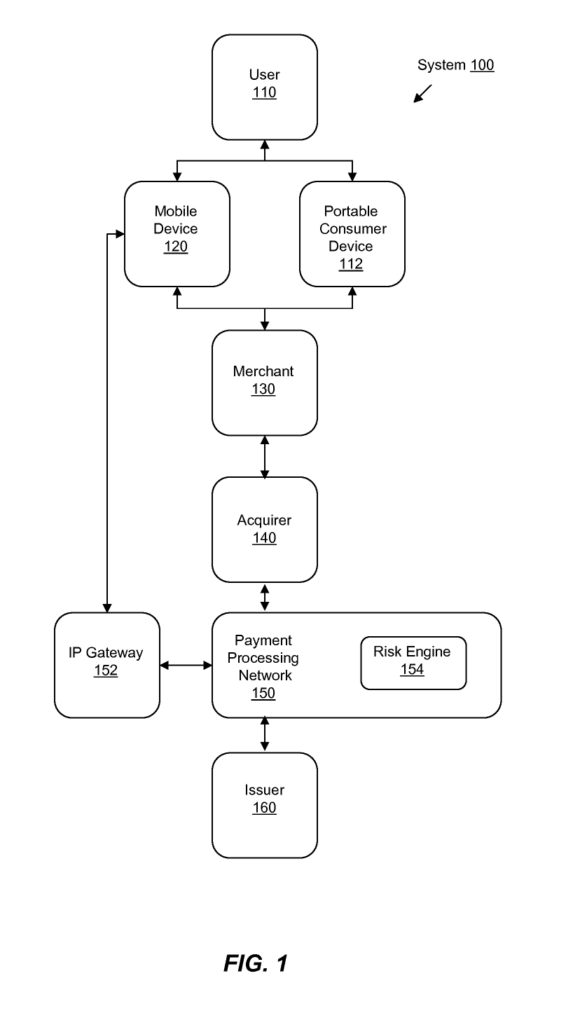

FIG. 1 illustrates a system 100 used for risk assessment in conjunction with performing an electronic payment transaction, communicating with a user via alert messages, and updating a risk system with response information from alert messages according to an embodiment of the innovations presented herein. System 100 may include user 110, portable consumer device 112, mobile device 120, merchant 130, acquirer 140, payment processing network 150, IP Gateway 152, risk engine 154, and issuer 160. Alternative embodiments may not include all of the above elements, and may include different combinations of the above elements.

User 110 may be a person, business, corporation that uses or interacts with portable consumer devices and mobile devices such as portable consumer device 112 and mobile device 120. User 110 may further refer to an individual or organization such as a business that is capable of purchasing goods or services or making any suitable payment transaction with merchant 130. During certain points in time, user 110 is in operative communication with mobile device 120. User 110 interacts with merchant 130 using the portable consumer device 112 and/or mobile device 120. Mobile device 120 is capable of communicating with the IP Gateway 152 for receiving alert messages that notify the user about recent transactions. Merchant is in communication with acquirer 140. Acquirer 140 is in communication with issuer 160 through payment processing network 150. IP Gateway 152 is also in communication with the payment processing network 152 for receiving transaction data and generating and delivering alert messages to the mobile device 120.

Portable consumer device 112 refers to any suitable device that allows the payment transaction to be conducted with merchant 130. Portable consumer device 112 may be in any suitable form. For example, suitable portable consumer devices 112 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 112 include cellular phones, personal digital assistants (PDAs), pagers, payment cards, security cards, access cards, smart media, transponders, and the like. In some cases, portable consumer device 112 may be associated with an account of user 110 such as a bank account.

Mobile device 120 may be in any suitable form. For example, a suitable mobile device 120 can be hand-held and compact so that the mobile device 120 can fit into a consumer's wallet and/or pocket (e.g., pocket-sized). Some examples of mobile device 120 include desktop or laptop computers, cellular phones, personal digital assistants (PDAs), pagers, payment cards, security cards, access cards, smart media, transponders, and the like. In certain embodiments, a mobile device may comprise a “smart phone” which is a phone that includes a processor and memory, and is capable of executing applications that may be used with aspects of the present innovations as discussed further below. In some embodiments, mobile device 120 and portable consumer device 112 are embodied in the same device.

Merchant 130 refers to any suitable entity or entities that make a payment transaction with user 110. Merchant 130 may use any suitable method to make the payment transaction. For example, merchant 130 may use an e-commerce business to allow the payment transaction to be conducted by merchant 130 and user 110 through the Internet. Other examples of merchant 130 include a department store, a gas station, a drug store, a grocery store, or other suitable business.

Acquirer 140 refers to any suitable entity that has an account with merchant 130. In some embodiments, issuer 160 may also be the acquirer 140.

Payment processing network 150 refers to a network of suitable entities that have information related to an account associated with portable consumer device 112. This information includes data associated with the account on portable consumer device 112 such as profile information, data, and other suitable information.

Payment processing network 150 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. Server computer may comprises one or more computational apparatuses and may use any of a variety of computing structures, arrangements, and compilations for servicing the requests from one or more client computers.

Payment processing network 150 may include data processing subsystems, networks, and operations used to support and deliver authorization services, exception file services, and clearing and settlement services. An exemplary payment processing network 150 may include VisaNet™. Networks that include VisaNet™ are able to process credit card transactions, debit card transactions, and other types of commercial transactions. VisaNet™, in particular, includes a integrated payments system (Integrated Payments system) which processes authorization requests and a Base II system which performs clearing and settlement services. Payment processing network 150 may use any suitable wired or wireless network, including the Internet.

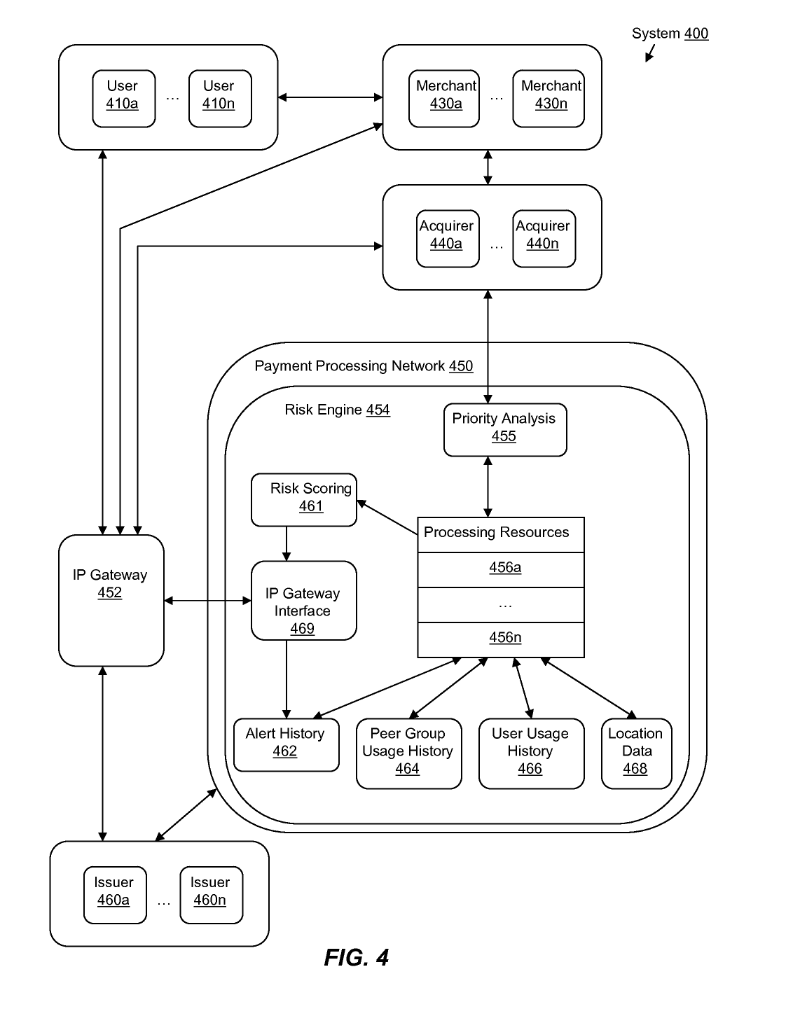

System 100 further comprises risk engine 154. In certain embodiments, risk engine 154 is created or disposed within payment processing network 150 as part of the payment processing network 150, and using the same hardware or server resources. In alternative embodiments, risk engine 154 is partially or entirely created separately from payment processing network 150, and is coupled to payment processing network 150 via a network connection. Additional embodiments and details related to risk engine 154 will be detailed below, especially with respect to FIG. 4.

IP Gateway 152 refers to an entity that includes one or more servers and databases, and have access to various issuer data, transaction data and user data used to generate and deliver notifications and alert messages to various delivery channels. IP Gateway 152 may be part of the payment processing network 150 or may be a separate entity in communication with payment processing network 150.

Issuer 160 refers to any suitable entity that may open and maintain an account associated with portable consumer device 112 for user 110. Some examples of issuers may be a bank, a business entity such as a retail store, or a governmental entity. In many cases, issuer 160 may also issue portable consumer device 112 associated with the account to user 110.

### II. Two Way Alert Messages and Message Customization in a Payment Processing System

In a typical payment transaction process, user 110 purchases goods or services by presenting his portable consumer device 112 to the merchant 130, merchant 130 generates an authorization request that includes, among other data, the data received from the portable consumer device 112. Merchant 130 sends the authorization request message to the acquirer 140. Acquirer 140 sends the authorization request to the payment processing network 150 which passes the authorization request to the issuer 160. Issuer 160 generates an authorization response that indicates whether the transaction is approved or declined. The authorization response is sent to the payment processing network 150.

An authorization request message may be a message that includes an issuer account identifier. The issuer account identifier may be a payment card account identifier associated with a payment card. The authorization request message may request that an issuer of the payment card authorize a transaction. An authorization request message according to an embodiment of the invention may comply with ISO 8583, which is a standard for systems that exchange electronic transactions made by cardholders using payment cards. Alternatively, embodiments may include other identifying information or portions of identifying information such as an account number, a card verification value (CVV), a card expiration date, a service code, a merchant ID, or other information associated with an account or portable consumer device 112 involved in the transaction.

According to embodiments of system 100, payment processing network 150 sends a message such as a copy of the authorization response, the authorization request, or both to IP Gateway 152 which generates an alert message to notify the user 110 about the transaction. The alert messages may be sent to the user via SMS, e-mail or smart-phone applications. Systems and methods for generating and delivering alert messages are described in detail in the U.S. patent application Ser. No. 12/563,586, entitled “Intelligent Alert System and Method,” filed Sep. 21, 2009; and U.S. patent application Ser. No. 12/720,627, entitled “Alert Architecture,” filed on Mar. 9, 2010, which are incorporated herein by reference.

The payment processing network 150 sends the authorization response to the acquirer 140 who informs the merchant 130 about the result. If user 110 receives an alert message which the user does not recognize and/or does not approve, user 110 may reply to that alert message and indicate that he does not recognize the transaction or does not approve the transaction.

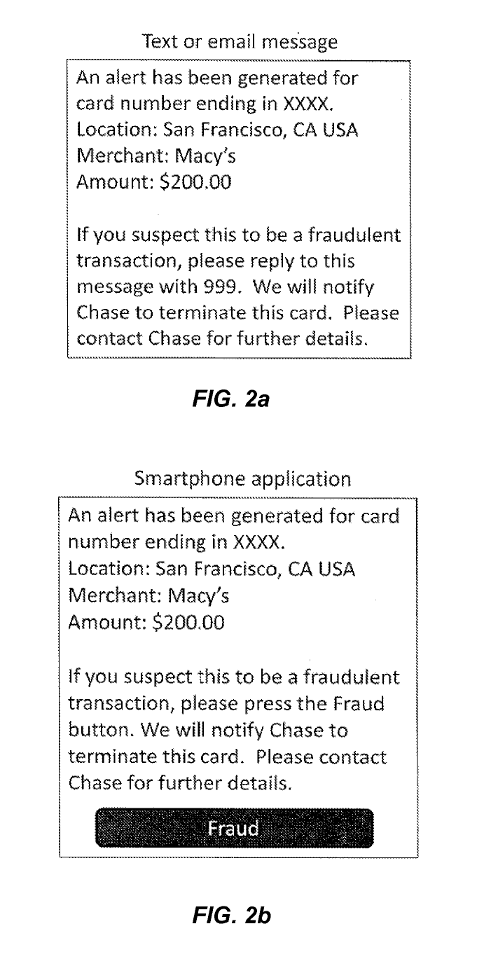

FIG. 2 illustrates examples of alert messages that a user may receive in which the user has the ability to reply to the message and inform the payment processing network and/or the issuer that he does not recognize the transaction. Systems and methods for replying to alert messages are also described in U.S. patent application Ser. No. 12/712,870, entitled “System and Method Including Indirect Approval,” filed on Feb. 25, 2010, which is hereby incorporated by reference. FIG. 2a illustrates an example of an alert message that may be transmitted to mobile device 120 via text message. The alert message identifies portable consumer device 112, merchant 130, and a transaction amount. The identification may be executed in a variety of ways, for example, an alert message may refer to merchant 130 using a merchant identifier number. Alternative embodiments of a text message according to embodiments of the present innovations may include user specified abbreviation language, urgency or risk levels associated with the transaction by risk engine 154, or a list of alternative mobile devices to which the alert has been communicated.

An alert message may further identify a method for responding to the alert message. In the example identified by FIG. 2a, the alert message includes text that requests a reply to the alert message in order to identify the transaction as potentially fraudulent. The alert message of FIG. 2a further details that the identified portable consumer device will be terminated as a safety precaution if the transaction is identified as potentially fraudulent. Alternative embodiments of an alert message may request a response indicating the transaction is identified by the user 110 as fraudulent or authorized within a specified period of time, with details of security precautions to be taken if no response occurs within the specified time frame.

FIG. 2b illustrates another alternative embodiment of an alert message according the present innovations. As described above, mobile device 120 may be a smart phone. In certain embodiments, a software application is executed by mobile device 120 in order to enable specialized messaging and alerts from risk engine 154. The smart phone application may operate continuously on mobile device 154, or may be activated by an alert received from IP Gateway 152. Alternatively, the smart phone application may operate to execute different types or levels of user alerts depending on a risk level identified in an alert message or in a setting of a smart phone application. As illustrated by FIG. 2b, an alert message presented by a smart phone application by mobile device 120 may present similar information to that presented by the message of FIG. 2a, including information that identifies portable consumer device 112, merchant 130, and a transaction amount.

In alternative embodiments, a payment processing network 150 or risk engine 154 may include or have access to message or alert customization data that may be used to create a custom message template that is used to generate the alert message. Such alert customization data may provide formatting or mobile device data. It may additionally identify third parties that may be contacted using alerts. It may additionally include data related to other accounts or portable consumer devices associated with the user, or any other information that may assist in fraud detection and protection for the user 110 or other users of payment processing network 150.

Payment processing network 150 may advantageously use the replies to the alert messages from users to predict possible future fraudulent transactions and prevent such transactions from taking place, by notifying appropriate parties and entities such as the issuer 160, acquirer 140, and merchant 130. In some embodiments, the payment processing network 150 engages the risk engine 154 that uses various pre-established schemes and algorithms to monitor the transactions and identify the potential transactions that may be fraudulent. Supplying the replies to the alert messages that are received from the users to the risk engine 154 provides more reliable data to the risk engine to predict other potential fraudulent transactions.

In one example, user 110 replies to an alert message indicating that the reported transaction is fraudulent. Payment processing network 150 passes the received reply message from the user 110 to risk engine 154. Risk engine 154 may monitor the transactions from the merchant that was involved with the transaction that was reported to the user 110. The indication that a merchant location was involved in a fraudulent transaction can help risk engine 154 to concentrate the resources at its disposal to monitor other transactions that originate from that merchant and prevent other potential fraudulent transactions from taking place.

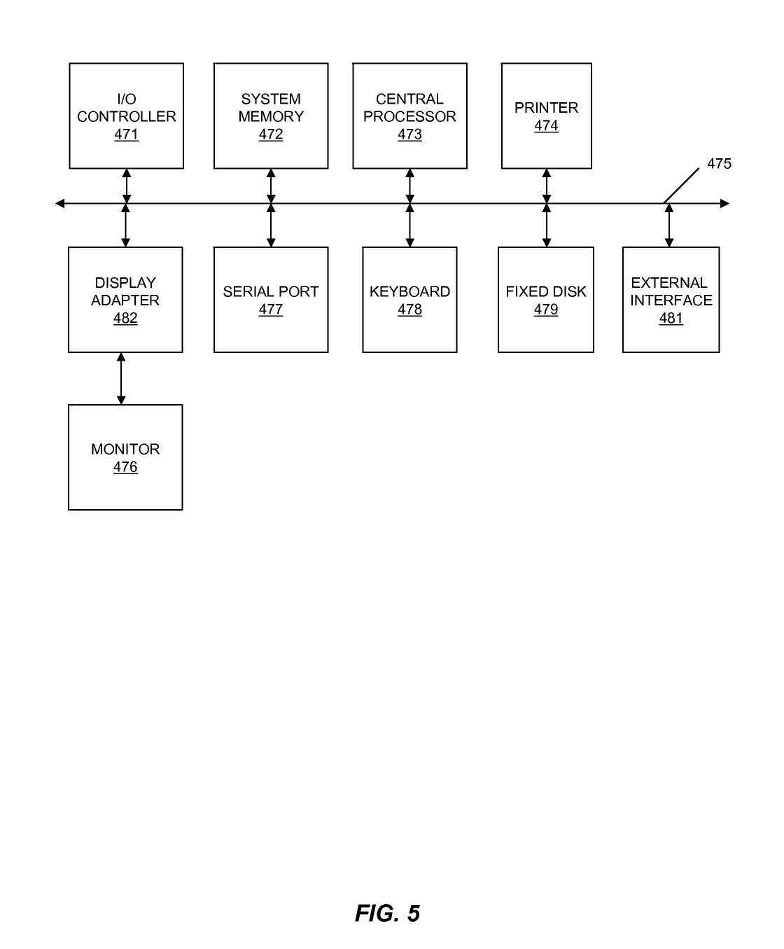

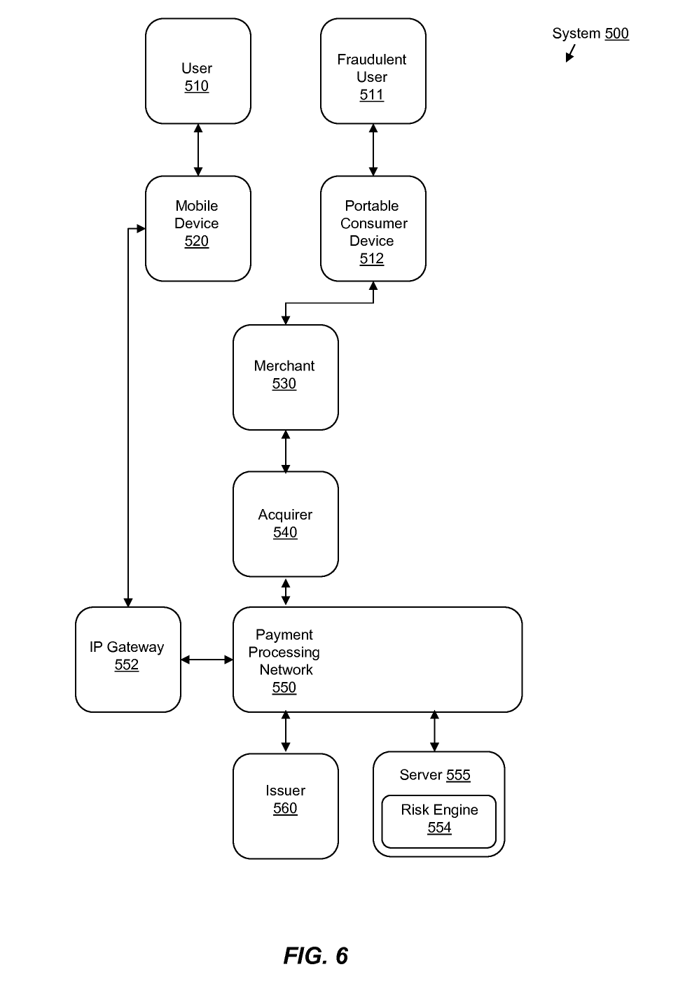

In another example, user 110 replies to an alert message indicating that a reported withdrawal was not performed by the user. The payment processing network 150 notifies the risk engine 154 about the transaction. Risk engine 154 may alter and/or update its risk scoring algorithm for future transactions matching this pattern. Other examples and embodiments are also shown in FIG. 5 and FIG. 6.

### III. Risk Assessment and Alert Process Flow in a Payment System

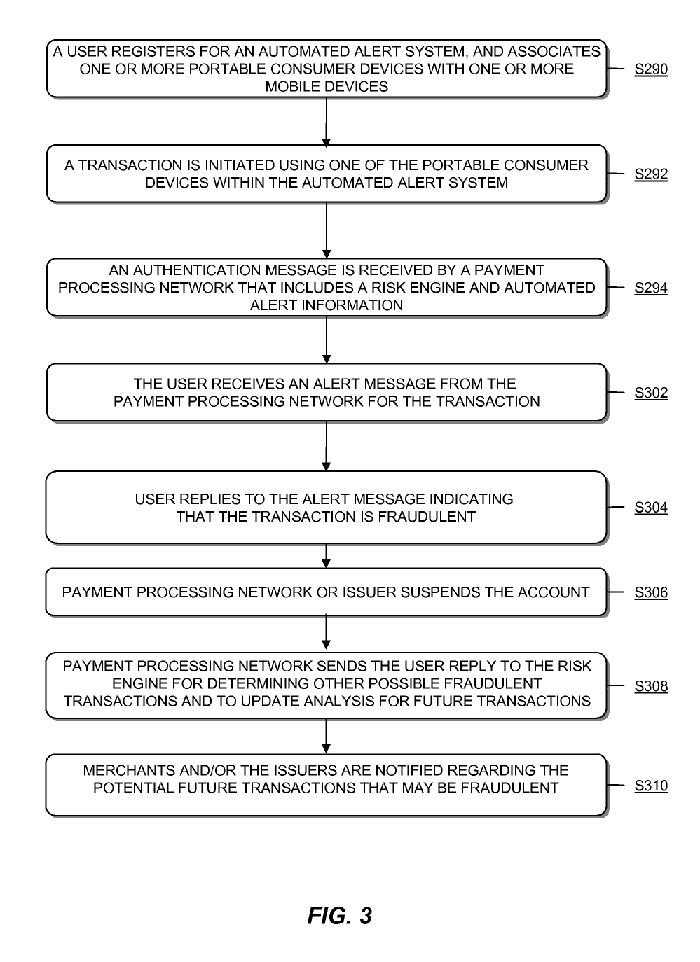

FIG. 3 is a flowchart that illustrates one potential embodiment of a process of using alert messages to track other potential fraudulent transactions. In certain embodiments, not all steps presented in FIG. 3 may be used. In additional embodiments, the steps of FIG. 3 may be used out of order or in conjunction with additional steps that are not described. As shown in step S290, a user may initially register with an automated alert system to enroll accounts, portable consumer devices, and/or mobile devices in a system for presenting alert information. In alternative embodiments, an account, portable consumer device, and mobile device may be enrolled automatically, with a users consent, in an alert system as part of the creation of an account associated with a portable consumer device, and prior to creation of the portable consumer device to be associated with the alert system.

At some point, a transaction is initiated using a portable consumer device such as portable consumer device 112 of FIG. 1. This is shown as step S292 of FIG. 3. For convenience and ease of understanding, the steps of FIG. 3 will be described with reference to the elements of FIG. 1. It is to be understood, however, that the steps of FIG. 3 may be used with many different system configurations, and are not limited to use with system 100 of FIG. 1. Following initiation of the transaction in step S292, an authentication message is transmitted from merchant 130 to acquirer 140, and in step S294 an authentication message is received at a payment processing network 150 as part of the transaction.

The payment processing network 150, includes a risk engine 154. In certain embodiments, payment processing network 150 may handle authentication for transactions on accounts that are registered with an alert system and for transactions on accounts that are not registered with the alert system. The following steps in such a system will only apply to the subset of transactions for accounts that are enrolled in the alert system. After the payment processing network 150 and risk engine 154 identify a specific transaction for use with an alert messaging system, in S302 the user 110 or user's mobile device 120 receives an alert message from the payment processing network 150 via IP Gateway 152. In step S304, a message is communicated from mobile device 120 to payment processing network 150 indicating that the user 110 does not recognize the transaction and that the transaction is likely to be fraudulent.

Following receipt of this message, the payment processing network 150 or the related issuer 160 suspends the account in step S306, and the risk engine 154 analyzes the details of the transaction to determine other possible fraudulent transactions in step S308. Additional details related to the analysis will be discussed below, especially with respect to FIG. 4. Finally in step S310, after the analysis of risk is complete, the risk engine 154 may cause a notification or alert message to be sent to merchants, acquirers, or issuers indicating potential future transactions that have a likelihood of being fraudulent.

Further, After analysis of risk is complete, risk engine 154 may update an analysis method used for future transactions. The update may only alter analysis for accounts and portable consumer IDs associated with user 110, or may update analysis for a group of user identified as being similar to user 110. Alternatively, a pattern associated with the transaction may be identified and all future transactions conforming to that pattern may use an updated analysis. In some situations, the updated analysis may apply to all future transactions. As discussed further below, updating an analysis may involve changing a risk factor or a risk scoring method for a user, set of users, a transaction pattern, a geographic area, a set of merchants, or for any other group identified as relevant to identifying fraud.

In alternative embodiments of system 100, the alert process may be done independently from a user registration, with the payment processing network functioning independently of any computing devices used for registration. In such a system, as shown in step S302, user 110 first receives an alert message informing him regarding a transactions. If the user 110 does not recognize the transaction, user 110 replies to the alert message indicating that the transaction is fraudulent. In some embodiments, the reply message will be sent to IP Gateway 152 which then notifies the risk engine 154 in the payment processing network 150. This is shown as step S304.

Next, as an optional step, the issuer 160 or the payment processing network 150 may suspend the account associated with user 110 to prevent other fraudulent transactions from taking place. In some embodiments, payment processing network 150 may send a notice to issuer 160 regarding the reply message received from user 110. This is shown as step S306. The payment processing network sends the user reply to the risk engine 154 for determining other possible fraudulent transactions from that particular merchant location or a pre-determined geographical area. In case of e-commerce transactions, risk engine 154 may focus on similar merchants that supply items that were involved in the fraudulent transactions. This is shown as step S308. In step S310, payment processing network 150 then notifies the merchant or other merchants that are identified by the risk engine 154 for being potential target of similar fraudulent transactions.

### IV. Risk Engine

FIG. 4 describes one potential implementation of a risk engine 454 operating within a payment processing system 400. System 400 includes a plurality of users 410a through 410n, a plurality of merchants 430a through 430n, a plurality of acquirers 440a through 440n, a plurality of issuers 460a through 460n, a payment processing network 450, an IP Gateway 452, and a risk engine 454. For the purposes of FIG. 4, it is implied that users 410a through 410n who use the alert system have associated portable consumer devices and mobile devices that are part of communications with merchants and the payment processing network as described in the embodiments above for FIG. 1.

In certain embodiments, payment processing network 450 is regularly receiving transaction information that flows from a large group of users, merchants, and acquirers. Each single transaction received among the large flow of transactions typically flows from a current user through a merchant to an acquirer, and on to the payment processing network 450. After the transaction information is received by payment processing network 450, some or all of the information may be passed to risk engine 454 for risk and fraud analysis. A priority analysis 455 may be done to determine an initial risk associated with any individual transaction, or simply to determine what resources to allocate to analysis of the individual transaction.

Processing resources 456a through 456n may include processor cycles or devices allocated to analysis, memory space allocated for permanent or temporary storage of related transactions, bandwidth in a communications resource to distributed processors, or other computing resources that may advantageously be allocated and used to asses risk and likelihood of fraud. Allocation of other resources may be assessed such as bandwidth available to IP Gateway 452 to communicate messages to users 410a through 410n and to prevent overloading of IP Gateway 452. Priority analysis 455 may use portions of processing resources 456 for a priority analysis, or processing analysis 455 may contain dedicated resources for the initial analysis and resource allocation.

Processing resources 456 may include or have access to non-transitory storage media that include information, details, and history that may be used for risk analysis of current and projected transactions. For example, processing resources 456 may access alert history 462 that includes a history of alerts for the current user or related users. Peer group usage history 464 may include pre-identified sets of information related to usage patterns of users that have been identified as similar to the user associated with the current transaction. User usage history 466 may include a usage history or a pattern analysis of the transaction history of the current user. Finally, location data 468 may include details about the location of a merchant associated with the current transaction for use in risk analysis, or location data associated with previous transactions initiated by the current user.

Weighted combinations or transformations of the above information combined with any other information used to determine risk may be combined to create a risk score using risk scoring 461. Risk scoring may be implemented as part of processing resources 456, in conjunction with them, or as a separate system. Such risk scoring may be done as part of an analysis of whether to send an alert message to the user. Alternatively, a simplified analysis may be done to save on processor resources. As an additional alternative, every transaction associated with an account enrolled in an alert system may have an associated alert message. Data for users not enrolled in an alert system may be used in risk analysis and scoring for users that are enrolled in the alert system.

For alert messages sent to users from the IP gateway interface 469 of risk engine 454 via IP Gateway 452, only a portion of the alert messages will have corresponding replies. Reply messages may simply involve an indication that an associated transaction was fraudulent, but in some embodiments, may identify that the transaction was not fraudulent, or some other indication allowed by the system, such as a third party risk message. In the embodiment described in FIG. 4, a reply message may be received by IP gateway interface 469, may be communicated to alert history 462, and then may be analyzed by processing resources 456 and/or priority analysis 455. In alternative embodiments, the reply message may be communicated directly to a priority analysis 455 system, or to another risk assessment interface.

Following receipt of a reply message indicating fraud, an initial action may be taken to deny future authentication of any request associated with accounts or portable consumer devices associated with the reply message, or a message may be sent to an associated issuer recommending such an action. Alternatively, an analysis may be performed by risk engine 454 prior to such an action. Such an analysis may include use of the information discussed above related to data stored in a risk engine 454. After the reply is received by risk engine 454 for risk and fraud analysis, a priority analysis 455 may be done to determine a risk associated with the reply, or simply to determine what resources to allocate to analysis of the individual reply.

Processing resources 456 may be assigned to perform a varying scope of risk analysis that may include an analysis of similar users, potential future transactions using other accounts of the user, or potential fraud in a related geographic area for other users. This may be done using information from alert history 462, peer group usage history 464, user usage history 466, and location data 468. Such data may be considered alert data or alert customization data, and may used to create an alert message. Such data may also be modified by a response to an alert, and used in fraud prediction and analysis. After an analysis associated with a reply message, and using alert customization data and the reply message data is completed, additional alert messages may be communicated to the merchant or acquirer involved in the transaction, or to other merchants, issuers, or acquirers based on location or other analysis done as part of the risk analysis. One potential alternative analysis, for example, may involve an identification of an abnormally large number of reply messages from accounts or users associated with a certain issuer or set of issuers. Such a pattern identified through a risk engine may identify a situation where a set of issuer accounts may have been compromised or stolen as a group. Another analysis may identify merchants within a certain geographic area that may have a heightened number of fraudulent transactions, even if the number of fraudulent transactions for an individual merchant is not abnormal.

Further, after an analysis associated with a reply message is complete, the analysis process may be adjusted. For example weighting values applied to an initial risk scoring may be updated or adjusted based on an analysis of the reply message or information associated with the reply message.

It can be appreciated that the embodiments of the invention provide many advantages. Incorporating a fraud prediction system with the payment processing network may improve the speed with which a transaction is identified as fraudulent, decreasing risk associated with transactions. The reply messages and data associated with reply messages from the users who are victims of fraudulent transactions may advantageously be used to strategically direct the resources available to prevent other potential fraudulent transactions from taking place. Utilizing such systems and methods may also generate substantial revenues as it saves the issuers and merchants significant amount of money that might otherwise be lost as a result of fraudulent transactions. An increased speed for identifying fraudulent transactions may also provide increased security and privacy for individuals associated with transactions by reducing instances of future fraud where a the user's personal information is compromised. Providing earlier identification and resolution for fraudulent transactions using a payment processing network may additionally provide intangible business advantages related to consumer satisfaction in a situation where stress is caused by identity theft and related fraud. Similar advantages may accrue from reduced inconvenience associated with account closure and correction of fraudulent transactions.

### V. Additional Embodiments

The various participants and elements of the system shown in the figures associated with the present innovations may operate one or more computers, computer apparatuses, or processing devices to facilitate the functions described herein. Such computer apparatuses or processing devices may be configured as individual servers, groups of servers, or virtual computing resources. Any of the elements in FIGS. 1, 4, 6, and 7 may use any suitable number of subsystems to facilitate the functions described herein. Additionally, elements of the mobile devices described throughout the descriptions of the present innovations may be structured according to FIG. 5 or in any other suitable configuration.

One non-limiting potential embodiment of such subsystems or components are shown in FIG. 5. The subsystems shown in FIG. 5 are interconnected via a system bus 475. Additional subsystems such as a printer 474, keyboard 478, fixed disk 479 (or other memory comprising computer readable media), monitor 476, which is coupled to display adapter 482, and others are shown. Peripherals and input/output (I/O) devices, which couple to I/O controller 471, can be connected to the computer system by any number of means known in the art, such as serial port 477. For example, serial port 477 or external interface 481 can be used to connect the computer apparatus to a wide area network such as the Internet, a mouse input device, or a scanner. The interconnection via system bus allows the central processor 473 to communicate with each subsystem and to control the execution of instructions from non-transitory system memory 472 or the fixed disk 479, as well as the exchange of information between subsystems. The system memory 472 and/or the fixed disk 479 may embody a computer readable storage medium. In alternative embodiments, a computing device according to aspects of the innovations described herein may be embodied with only a portion of the elements described in FIG. 5, with additional elements, or with some elements duplicated. Additionally, in further embodiments, elements may be located remotely from each other, being connected by the Internet, a wide-area network, or some other connection that enables communication between the elements.

Additionally, for the purposes of the innovations herein, a server computer can be a powerful computer or a cluster of computers. For example, the server computer can be a large mainframe, a minicomputer cluster, or a group of servers functioning as a unit. In one example, the server computer may be a database server coupled to a Web server.

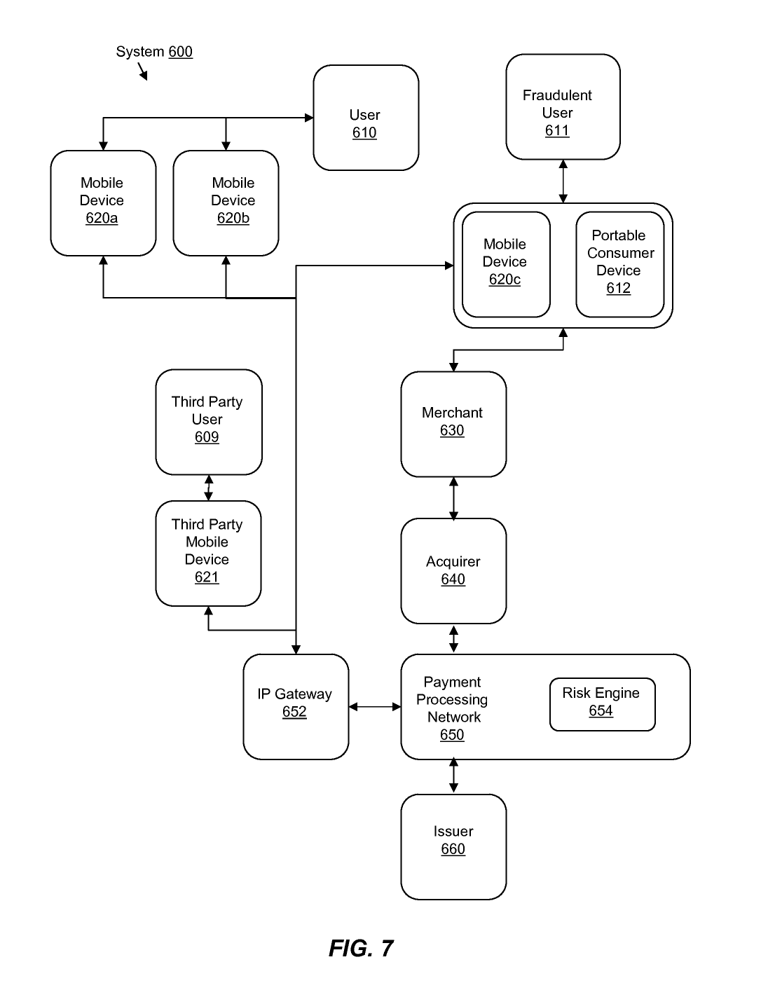

FIGS. 6 and 7 describe additional embodiments of systems in accordance with the present innovations, specifically illustrating systems in which fraud is occurring. In a normal system without fraud, such as the system of FIG. 1, a user 110 is expected to be in communication with mobile device 120 and to have physical access to portable consumer device 112. As shown in system 500 of FIG. 6, in certain cases of fraud, a fraudulent user 511 has access to portable consumer device 512 or information that allows fraudulent user 511 to indicate to a payment processing network 550 that fraudulent user 511 is user 510 and has access to portable consumer device 512. In such an instance, an authentication message may be created by merchant 530 in response to a transaction initiated by fraudulent user 511. After the message is passed to payment processing network 550 through acquirer 540, information for risk analysis is transmitted to server 555 which contains risk engine 554. Risk engine 554 and issuer 560 may not have sufficient information to identify the transaction as fraudulent or authentic. Risk engine 554 may communicate an alert message to user 510 via payment processing network 550, IP Gateway 552 and mobile device 520, when mobile device 520 has been associated with portable consumer device 512. In certain embodiments, the message may be sent prior to authorization of the transaction request.

In alternative embodiments, the authorization request has limitations on an amount of time available prior to response to the authorization message, and the alert is sent after the transaction has been approved or denied. In one such embodiment, a transaction is denied, an alert message is sent, a reply is received indicating the transaction is not fraudulent, and a subsequent similar transaction on the same account is approved. Such a subsequent transaction may occur in near real time, such that the message and reply are sent and received, and a subsequent transaction is approved within roughly 30 seconds.

In FIG. 6, after the alert message is received a reply indicating fraudulent use is received, the transaction proceeds as described by FIG. 3, with the associated account being canceled, and an analysis of potential future fraud occurring. Further, in FIG. 6, risk engine 554 is structured in server 555 to be separate from payment processing network 550. Such an embodiment may be structured to function essentially in the same way as when risk engine 554 is incorporated with payment processing network 550, but may include additional communication protocols and structure for interfacing with payment processing network 550.

In FIG. 7 a further alternative embodiment where fraud is occurring is illustrated. In system 600 of FIG. 7, a user 610 has associated multiple mobile devices 620a, 620b, and 620c with portable consumer device 612. Additionally, a mobile device 621 that is associated with a third party user 609 is associated with portable consumer device 612. Third party user 609 may be a manager or person with signing authority associated with a corporation. Third party user 609 may further be associated with both user 610 and portable consumer device 612. Third party user 609 may alternatively be a contact identified by user 610 and given permission to respond to alert messages in embodiments of the system with multiple levels of alert priority and multiple reply options. Additionally, in the embodiment of FIG. 7, portable consumer device 612 and mobile device 620 are embodied in the same device, such as a smart phone.

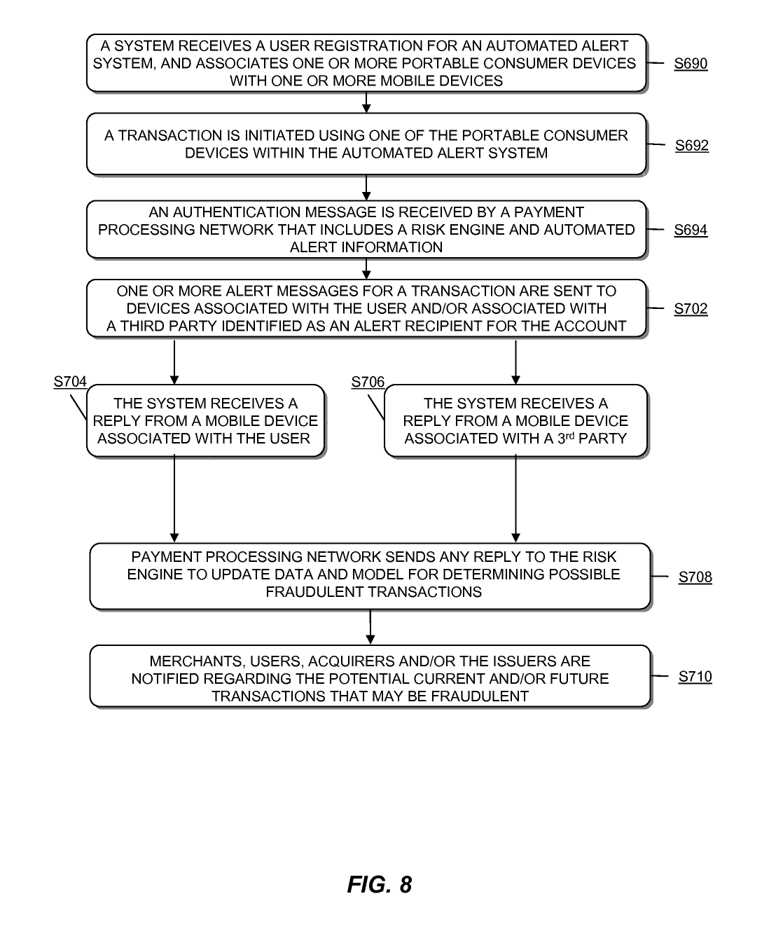

FIG. 8 illustrates a process flow in a system such as the system of FIG. 7. In step S690, multiple mobile devices 620 and/or third party users 609 and third party mobile devices 621 are associated with portable consumer device 612. In step S692 an authorization message for a transaction is initiated by fraudulent user 611. In step S694, the authorization message is conveyed to payment processing network 650 via merchant 630 and acquirer 640, and in step S702 an alert message is sent to several mobile devices. The system may receive replies from a mobile device 620 registered with the user in S704, and may concurrently receive a reply from a mobile device associated with a third party user 609 in step S706. In step S708, the risk engine receives any replies to alert messages, and updates data and models related to potential future fraud.

In one potential embodiment, the third party mobile device 621 comprises a website or message system associated with a social networking community, and gives members of the community an opportunity to indicate that they believe the recent transaction may be fraudulent. Risk engine 654 may respond to such messages with a lower risk response than such a message received from a user 610. Alternatively, such a response may adjust a priority analysis for allocation of processing resources, and may activate repeated messaging, messaging to further third party users or third party non-users, or may activate higher priority messaging system such as automated or in-person telephone messaging. Further, such responses may adjust a probabilistic analysis related to potential future fraudulent transactions.

Finally, in step S710, merchants, users, acquirers, and or issuers may be notified regarding potential future fraudulent transactions. Such notification may occur through a channel such as the embodiments of an IP Gateway from a payment processing network described above, or through additional communication paths that may be part of a subscription to a service.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present innovations presented herein can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. Steps identified as embodiments of the present invention may be performed out of the order directly presented, and may be implemented with different steps or only as a portion of the steps resented. The scope of the invention should, therefore, be determined not with reference to the above description, but instead should be determined with reference to the pending claims along with their full scope or equivalents.

What is claimed is:

1. A method comprising:
sending an alert message to a mobile device associated with a portable consumer device, wherein the alert message provides notification of a recent transaction related to an account that is associated with the portable consumer device;
receiving a reply message in response to the alert message, wherein the reply message indicates that the recent transaction is fraudulent; and
updating a risk engine with data associated with the reply message.

2. The method of claim 1, wherein updating the risk engine with data associated with the reply message comprises configuring the risk engine to identify other potential fraudulent transactions.

3. The method of claim 1, wherein updating the risk engine with data associated with the reply message comprises increased monitoring of other transactions originating from a merchant that was involved with the recent transaction.

4. The method of claim 1, wherein updating the risk engine with data associated with the reply message comprises increased monitoring of a set of similar merchants to identify other potentially fraudulent transactions.

5. The method of claim 4 wherein the set of similar merchants comprise merchants within a pre-determined geographical area.

6. The method of claim 1, wherein the portable consumer device is a cellular phone.

7. The method of claim 6, wherein the mobile device is the cellular phone.

8. The method of claim 1 further comprising sending a notifying message to an issuer in response to the reply message.

9. The method of claim 3 further comprising sending a notifying message to the merchant indicating a prediction of future fraudulent transactions.

10. The method of claim 1 wherein the risk engine comprises a database, and the database comprises alert data;
wherein the alert message is generated using the recent transaction and the alert data; and
wherein updating the risk engine with data associated with the reply message comprises modifying the alert data.

11. The method of claim 10 wherein the database further comprises user submitted data that is present prior to the sending of the alert message.

12. The method of claim 10 wherein the alert message is further generated using a merchant identifier to determine a message template that is used to generate the alert message, and wherein the alert message includes information related to the recent transaction.

13. The method of claim 10 wherein the database further comprises a plurality of issuer data, and wherein the alert message further comprises the plurality of issuer data from the database.

14. The method of claim 1 wherein the mobile device is further associated with a third party user.

15. The method of claim 1 further comprising sending the alert message to a second mobile device that is associated with the portable consumer device.

16. A system comprising:
a non-transitory computer readable storage medium; and
a processor coupled to the computer readable storage medium, wherein the processor is configured to execute program code stored on the computer readable storage medium to perform a method comprising:
initiating an alert message to a mobile device associated with a portable consumer device, wherein the alert message provides notification of a recent transaction related to an account that is associated with the portable consumer device;
receiving a reply message in response to the alert message; and
updating a risk engine with data associated with the reply message.

17. The system of claim 16 wherein the risk engine comprises a database, and the database comprises alert data;
wherein the alert message is generated using the recent transaction and the alert data; and
wherein updating the risk engine with data associated with the reply message comprises modifying the alert data.

18. The system of claim 16 wherein the method further comprises sending a notifying message to a merchant indicating a prediction of future fraudulent transactions.

19. The system of claim 16, wherein updating the risk engine with data associated with the reply message comprises increased monitoring of a set of similar merchants to identify other potentially fraudulent transactions.

20. The system of claim 19 wherein updating the risk engine with data associated with the reply message comprises configuring the risk engine to identify other potential fraudulent transactions based on reply data indicating that the recent transaction was not fraudulent.
